(19) United States
(12) Patent Application Publication
(10) Pub. No.: US 2017/0047990 A1
(43) Pub. Date: Feb. 16, 2017

(54) WAVELENGTH DIVISION MULTIPLEXING TRANSMISSION SYSTEM

(71) Applicant: FUJITSU LIMITED, Kawasaki-shi (JP)

(72) Inventors: Akihisa KAWAGUCHI, Kawasaki (JP); Koji TANONAKA, Kawasaki (JP); Tonoyuki SUZUKI, Kawasaki (JP); Reiko SATO, Kawasaki (JP); Akihide KASEZAWA, Kawasaki (JP); Shoichi MURAKAMI, Kawasaki (JP); Ryo KARUBE, Kawasaki (JP)

(73) Assignee: FUJITSU LIMITED, Kawasaki-shi (JP)

(21) Appl. No.: 15/237,051

(22) Filed: Aug. 15, 2016

(30) Foreign Application Priority Data
Aug. 14, 2015 (JP) 2015-160067

(51) Int. Cl. H04B 10/032; H04B 10/079; H04Q 11/00; H04J 14/02

(52) U.S. Cl. CPC H04B 10/032; H04J 14/0212; H04B 10/07955; H04Q 11/0066; H04Q 2011/0016; H04Q 2011/0081

(57) ABSTRACT

In a wavelength division multiplexing transmission system, a controller of a relay node of a post-stage notifies level decrease information to a transmission node, upon detecting a decrease in a level of a wavelength in a wavelength multiplex signal received from the transmission node of a pre-stage by the optical channel monitor of the transmission node. The controller of the transmission node of the pre-stage determines that a failure occurs in the wavelength of the transponder of the transmission node, upon detecting a decrease in the level of the wavelength in the wavelength multiplex signal transmitted to the relay node by the optical channel monitor of the transmission node and upon receiving the level decrease information for the wavelength from the relay node. Therefore, a wavelength channel failure in the transponder can be determined in a preferable manner.

### CROSS-REFERENCE TO RELATED APPLICATION

This application is based upon and claims the benefit of priority of the prior Japanese Application No. 2015-160067 filed on Aug. 14, 2015 in Japan, the entire contents of which are hereby incorporated by reference.

### FIELD

The embodiment(s) discussed herein relates to a wavelength division multiplexing transmission system to transmit and receive an optical signal through an optical transmission path.

### BACKGROUND

As the Internet rapidly spreads in recent years, a wavelength division multiplexing (WDM) transmission system for collectively transmitting optical signals of multiple wavelengths through a single optical fiber has been developed and introduced. Currently, a mainstream of a transmission speed per wavelength is 2.4 Gbps to 10 Gbps, but in order to support a still increasing information transmission demand, a higher transmission speed such as Gbps is beginning to be employed.

In such a WDM transmission system, an optical channel monitor (OCM) detects a signal wavelength-division-multiplexed by a multiplexer (MUX) that multiplexes wavelength signals, and a feedback control is performed for a wavelength selective switch (WSS) so that optical levels for each wavelength become constant.

In the wavelength division multiplexing transmission system, when the optical level of each wavelength detected by the optical channel monitor repeatedly increases and decreases or when the detection level of the optical channel monitor does not increase even though the level control is performed with the wavelength selective switch, it is determined that a wavelength channel failure has occurred, and the output of the transponder is stopped to prevent an impact on the other signals.

Patent Document 1: JP 2014-239340 A

However, in the above conventional wavelength division multiplexing transmission system, when a failure such as an unavailable detection for the optical level of each wavelength is occurred due to the failure of the optical channel monitor, it is unavailable to determine that the failure is caused by the failure of the optical channel monitor. Therefore, there is a possibility to cause a signal interruption because the output of the transponder is stopped.

### SUMMARY

In one aspect, a wavelength division multiplexing transmission system includes a first wavelength division multiplexing transmission apparatus, and a second wavelength division multiplexing transmission apparatus disposed at a post-stage of the first wavelength division multiplexing transmission apparatus. Each of the first and second wavelength division multiplexing transmission apparatuses includes a transponder configured to convert a client signal into optical signals with a plurality of different wavelengths, a multiplexer configured to wavelength-division-multiplexes the optical signals with the plurality of wavelengths from the transponder, an optical level detector configured to detect an optical level of each wavelength input into the multiplexer from the transponder, a wavelength selective switch configured to selectively add or drop the optical signal from a pre-stage apparatus and the wavelength multiplex signal from the multiplexer, or to selectively allow the optical signal from a pre-stage apparatus and the wavelength multiplex signal from the multiplexer to pass through, an optical channel monitor configured to detect an optical level of each wavelength of the wavelength multiplex signal, an optical switch provided at a pre-stage of the optical channel monitor, and configured to input any one of the wavelength multiplex signal received from the pre-stage apparatus and a wavelength multiplex signal transmitted to a post-stage apparatus into the optical channel monitor, and a controller configured to control each constituent element of the wavelength division multiplexing transmission apparatus. The controller of the second wavelength division multiplexing transmission apparatus notifies level decrease information to the first wavelength division multiplexing transmission apparatus, upon detecting a decrease in a level of a wavelength in the wavelength multiplex signal received from the first wavelength division multiplexing transmission apparatus by the optical channel monitor of the second wavelength division multiplexing transmission apparatus. The controller of the first wavelength division multiplexing transmission apparatus determines that a failure occurs in the wavelength of the transponder of the first wavelength division multiplexing transmission apparatus, upon detecting a decrease in the level of the wavelength in the wavelength multiplex signal transmitted to the second wavelength division multiplexing transmission apparatus by the optical channel monitor of the first wavelength division multiplexing transmission apparatus and upon receiving the level decrease information for the wavelength from the second wavelength division multiplexing transmission apparatus.

In another aspect, a wavelength division multiplexing transmission system includes a first wavelength division multiplexing transmission apparatus, and a second wavelength division multiplexing transmission apparatus disposed at a post-stage of the first wavelength division multiplexing transmission apparatus. Each of the wavelength division multiplexing transmission apparatuses includes a transponder configured to convert a client signal into optical signals with a plurality of different wavelengths and to detect a code error of the optical signal of each wavelength, a multiplexer configured to wavelength-division-multiplexes the optical signals with the plurality of wavelengths from the transponder, an optical level detector configured to detect an optical level of each wavelength input into the multiplexer from the transponder, a wavelength selective switch configured to selectively add or drop the optical signal from a pre-stage apparatus and the wavelength multiplex signal from the multiplexer, or to selectively allow the optical signal from the pre-stage apparatus and the wavelength multiplex signal from the multiplexer to pass through, an optical channel monitor configured to detect an optical level of each wavelength in the wavelength multiplex signal, a transmission optical amplifier configured to amplify a wavelength multiplex signal from the wavelength selective switch and to transmit the wavelength multiplexed signal to a post-stage apparatus, a reception optical amplifier configured to amplify a wavelength multiplex signal received from the post-stage apparatus to input the wavelength multiplexed signal into the wavelength selective switch, and a controller configured to control each constituent element of the wavelength division multiplexing transmission apparatus. The controller of the first wavelength division multiplexing transmission apparatus fixes a gain of the transmission optical amplifier of the first wavelength division multiplexing transmission apparatus, and notifies wavelength channel alarm information of a wavelength to the second wavelength division multiplexing transmission apparatus, upon detecting a decrease in a level of the wavelength in the wavelength multiplex signal by the optical channel monitor of the first wavelength division multiplexing transmission apparatus. The controller of the second wavelength division multiplexing transmission apparatus fixes a gain of the reception optical amplifier of the second wavelength division multiplexing transmission apparatus upon receiving the wavelength channel alarm information, and notifies receive wavelength channel fail information to the first wavelength division multiplexing transmission apparatus upon detecting an occurrence of a code error in the optical signal of the wavelength by the transponder of the second wavelength division multiplexing transmission apparatus. The first wavelength division multiplexing transmission apparatus determines that a failure occurs in the wavelength of the transponder of the first wavelength division multiplexing transmission apparatus upon receiving the receive wavelength channel fail information.

Those obtained by converting any given combination of the above constituent elements and the expression into an apparatus, a method, a system, a program, a recording medium storing the program, and the like are also effective as still other aspects.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a schematic configuration of a wavelength division multiplexing apparatus used in a wavelength division multiplexing transmission system according to an embodiment;

FIG. 2 is a diagram illustrating a configuration of a wavelength division multiplexing transmission system;

FIG. 3 is a diagram illustrating an image of an optical signal in a case where a wavelength channel failure occurs;

FIG. 4 is a diagram illustrating a wavelength division multiplexing transmission system according to an embodiment;

FIG. 5 is a diagram illustrating a wavelength channel failure determination in the wavelength division multiplexing transmission system according to an embodiment;

FIG. 6 is a flowchart illustrating wavelength monitor processing in an optical channel monitor;

FIG. 7 is a flowchart illustrating determination processing upon detecting a wavelength channel failure;

FIG. 8 is a diagram illustrating a wavelength division multiplexing transmission system according to another embodiment;

FIG. 9 is a diagram illustrating wavelength channel failure determination in a wavelength division multiplexing transmission system according to another embodiment;

FIG. 10 is a flowchart illustrating wavelength monitor processing in an optical channel monitor; and

FIG. 11 is a flowchart illustrating determination processing of a reception wavelength failure.

### DESCRIPTION OF THE PREFERRED EMBODIMENTS

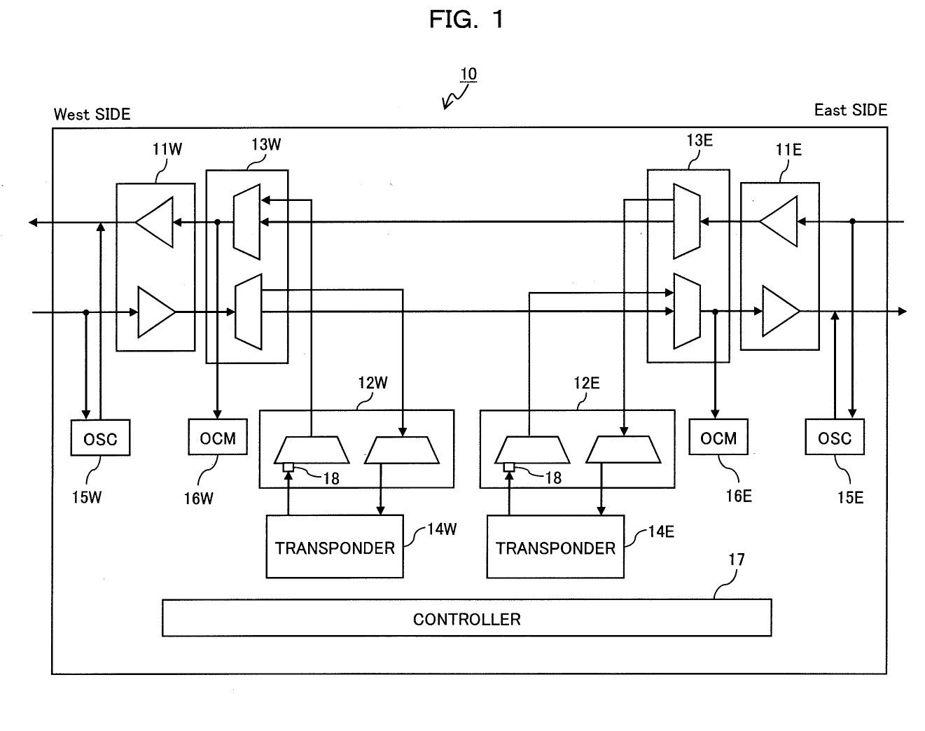

FIG. 1 is a diagram illustrating a schematic configuration of a wavelength division multiplexing (WDM) apparatus 10 used in a WDM transmission system according to an embodiment. As illustrated in FIG. 1, the WDM apparatus 10 include optical amplifiers 11W and 11E, multiplexers 12W and 12E, wavelength selective switches (WSSs) 13W and 13E, transponder blocks 14W and 14E, OSC (Optical Supervisory Channel) units 15W and 15E, optical channel monitors (OCMs) 16W and 16E, and a controller 17. As numeral references for constituent elements of the WDM apparatus 10, the one located at a west side will be attached with “W” and the one located at an east side will be attached with “E” where the upper side of FIG. 1 is the north. The WDM apparatus 10 is available to communicate with an apparatus (node) connected to the west side and an apparatus (node) connected to the east side.

The optical amplifiers 11W and 11E have a function available to receive and amplify a WDM signal and available to amplify and transmit a WDM signal. The multiplexers 12W and 12E are available to wavelength-division-multiplex a narrow band light from the transponder blocks 14W and 14E and available to separate multiplexed light. The inputs of the multiplexers 12W and 12E are provided with PDs (photodiodes) to detect input optical levels from the transponder blocks 14W and 14E. The WSSs 13W and 13E have a function available to add or drop an optical signal or to allow an optical signal to pass through (Add/Drop/Through). The transponder blocks 14W and 14E convert a client signal into an electric signal and convert the electric signal into a narrow band light, and further convert the narrow band light into a wide band light. The transponder blocks 14W and 14E have a function available to measure a code error of a received optical main signal. The OSC units 15W and 15E transmit and receive OSC signals to and from an adjacent node. The OSC signal is a signal used for a control, a monitor, and the like of the apparatus. An optical signal having a wavelength different from the optical main signal is used for the OSC signal. The optical channel monitor detects an optical level of each wavelength of the WDM signal that is output from the WSSs 13W and 13E. Optical level information is fed back to the WSSs 13W and 13E. The WSSs 13W and 13E adjust the optical level of each wavelength so that the optical levels for each wavelength become constant level. The controller 17 performs setting control and monitor for each constituent elements of the WDM apparatus 10, and performs monitor control communication with an adjacent node with the OSC signal.

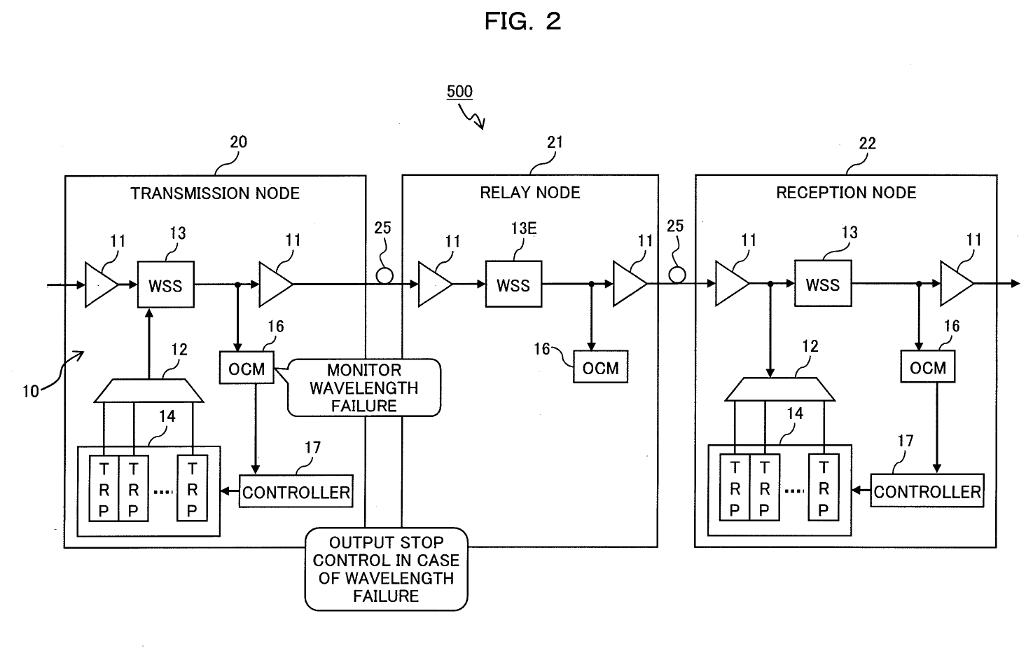

Next, before the WDM transmission system according to an embodiment is explained, a comparative example of a WDM transmission system will be explained with reference to FIG. 2. FIG. 2 illustrates a configuration of a WDM transmission system 500. In FIG. 2, a unidirectional signal flow (West side or East side) between nodes (WDM transmission apparatuses) is illustrated.

Optical signals from transponders (TRPs) in a transponder block 14 of a transmission node 20 are multiplexed by the multiplexer 12 and input into the WSS 13. The WSS 13 multiplexes an added signal obtained by multiplexing the optical signals from the transponder block 14 by the multiplexer and a relay signal (through signal) sent from a pre-stage apparatus. The multiplexed signal is transferred by the optical amplifier 11 to a post-stage apparatus (relay node 21). The OCM 16 of the transmission node 20 detects optical levels for each wavelength of the WDM signal. The WSS 13 performs an optical level adjustment so that the optical levels for each wavelength become equal.

The WDM signal transmitted from the transmission node 20 is received by a reception node 22 through the relay node 21. In the reception node 22, the WDM signal received from the optical transmission path 25 is amplified by the optical amplifier 11 and is then separated by the WSS 13 into a through signal and a dropped signal. The dropped signal is wavelength-demultiplexed by the multiplexer 12 and input into the transponder block 14. A usage state of a wavelength (WCS: Wavelength Channel Service) and a failure state (WCF: Wavelength Channel Fail) are exchanged between the nodes as wavelength information by using the OSC signal, and accordingly, a gain of the optical amplifier 11 is adjusted.

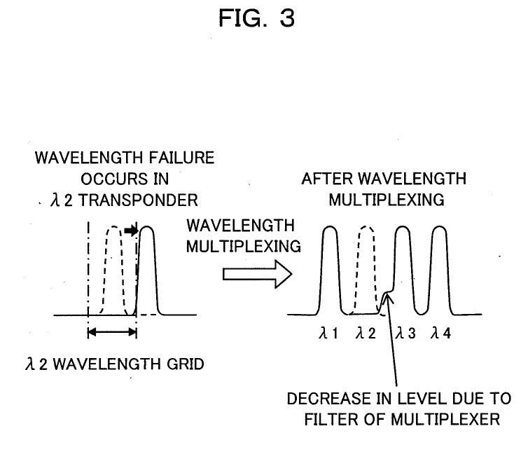

FIG. 3 illustrates an image of an optical signal in a case where a wavelength channel failure occurs. As illustrated in FIG. 3, when a failure (missing wavelength) occurs in an output wavelength of a transponder for a wavelength λ2 in the transponder block 14, the level of the signal of which a wavelength channel failure has occurred is cut by an arrayed waveguide grating (AWG) and the like of the multiplexer 12, and therefore, the corresponding wavelength is not input into the WSS 13. In this case, the PD 18 of the multiplexer 12 (see FIG. 1) detects the input optical level but the OCM 16 does not detect the optical level of the corresponding wavelength, and therefore, the controller 17 determines that a wavelength channel failure may be occurred.

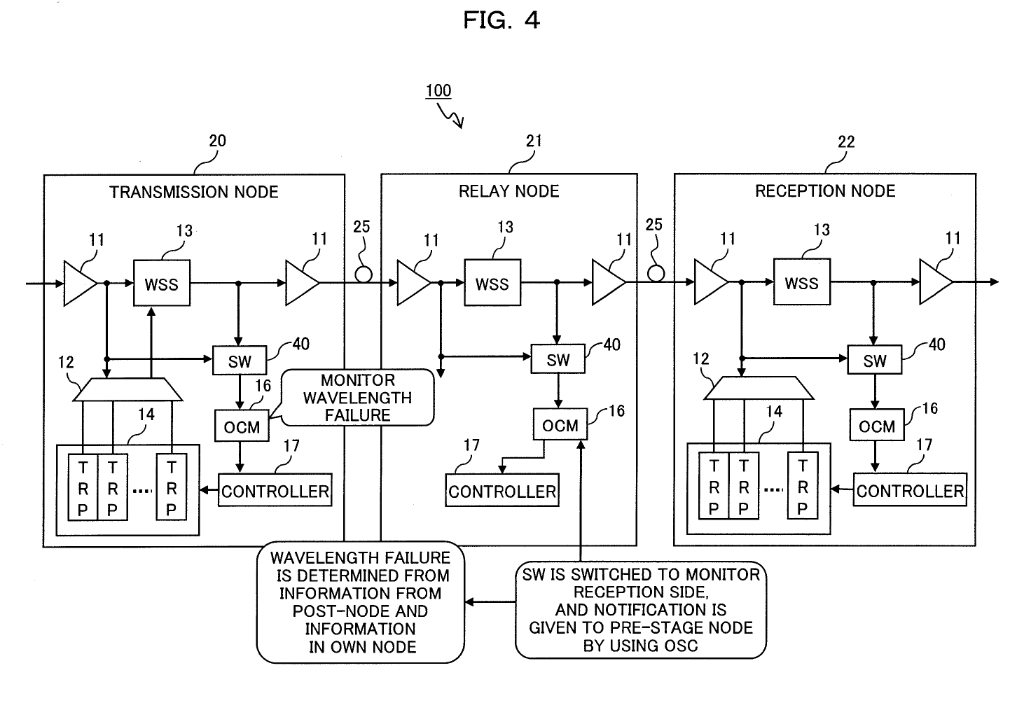

FIG. 4 is a diagram illustrating a WDM transmission system 100 according to an embodiment. As illustrated in FIG. 4, in the present embodiment, each node (WDM transmission apparatus) is provided with an optical switch 40 at a pre-stage of the OCM 16. The optical switch 40 inputs any one of a WDM signal received from a pre-stage node (a pre-stage apparatus) and a WDM signal transmitted to a post-stage node (a post-stage apparatus) into the OCM 16. By switching the optical switch 40 at a constant cycle (for example, about 50 ms to 100 ms), it is possible to monitor the wavelength optical levels of both of the WDM signal received from the pre-stage node and the WDM signal transmitted to the post-stage node.

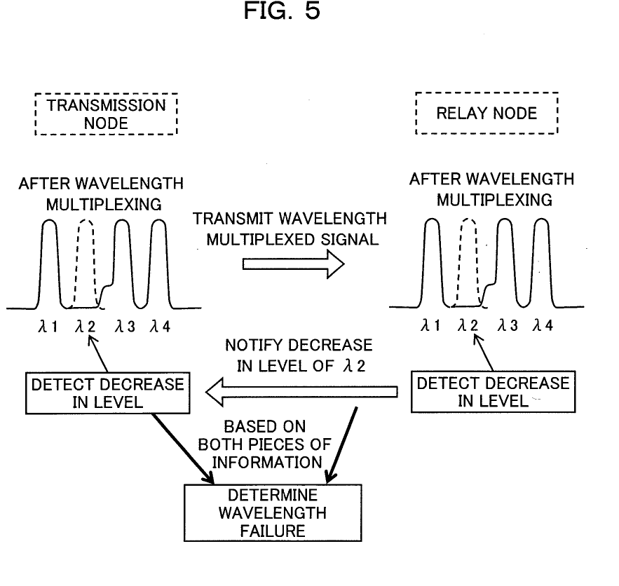

FIG. 5 is a diagram illustrating a wavelength channel failure determination in the WDM transmission system 100 according to an embodiment. An operation of the WDM transmission system 100 will be explained with reference to FIGS. 4 and 5. In this case, the transmission node 20 corresponds to a pre-stage node, and the relay node 21 corresponds to a post-stage node.

Firstly, an operation to be performed when a failure occurs in a certain wavelength (22 in this case) in the transponder block 14 of the transmission node 20 at the pre-stage will be explained. In this case, the OCM 16 of the relay node 21 at the post-stage also detects a decrease in the level of the wavelength λ2. When the OCM 16 of the relay node 21 detects the decrease in the level of the wavelength λ2 in the WDM signal received from the transmission node 20 at the pre-stage, the controller 17 of the relay node 21 at the post-stage notifies level decrease information to the transmission node 20. The level decrease information is notified by using the OSC signal. When the OCM 16 of the transmission node 20 detects a decrease in the level of the wavelength λ2 in the WDN signal transmitted to the relay node 21, the controller 17 of the transmission node 20 at the pre-stage monitors a notification from the post-stage node for a certain period. When the controller 17 of the transmission node 20 receives the level decrease information of the wavelength λ2 from the relay node 21, the controller 17 of the transmission node 20 determines that a failure occurs in the wavelength λ2 of the transponder block 14 of the transmission node 20.

Further, when the controller 17 of the transmission node 20 determines that a failure occurs in a certain wavelength (λ2) in the transponder block 14 of the transmission node 20, the controller 17 of the transmission node 20 stops the output of the optical signal of the wavelength λ2 from the transponder block 14. Since the optical amplifier 11 of the WDM transmission apparatus ordinarily determines a gain by counting the number of wavelengths, when a failure occurs in a certain wavelength and the optical level of the wavelength decreases, the gain may be changed and such change affects optical signals other than the failure-occurred wavelength. According to the WDM transmission system 100 in the present embodiment, when a failure occurs in a certain wavelength, since the output of the optical signal of the certain wavelength is stopped, it is possible to prevent an impact on the optical signals of the other wavelengths. When the controller 17 of the transmission node 20 determines that a failure occurs in the wavelength of the transponder block 14 of the transmission node 20, the controller 17 of the transmission node 20 notifies an alarm to a host monitor apparatus.

Next, it is assumed that a failure occurs in a certain wavelength (λ2) in the transponder block 14 of the transmission node 20 at the pre-stage. In this case, the transmission node 20 detects a decrease in the level of the wavelength λ2 but the OCM 16 of the relay node 21 at the post-stage does not detect the decrease. In a case where even though the optical channel monitor 16 of the transmission node 20 detects a decrease in the level of the wavelength λ2 in the WDM signal transmitted to the relay node 21 but the controller 17 of the transmission node 20 has not received any level decrease information of the wavelength λ2 from the relay node 21, the controller 17 of the transmission node 20 determines that a failure occurs in the OCM 16 of the transmission node 20. In this case, the controller 17 of the transmission node 20 notifies an alarm to the host monitor apparatus, and stops the feedback control of the optical level performed based on information from the OCM 16 for the WSS 13. Therefore, it is possible to prevent the failure of the OCM 16 from affecting the optical level control by the WSS 13.

Meanwhile, in a case where even though the OCM 16 of the relay node 21 detects a decrease in the level of a certain wavelength (λ2) but the OCM 16 of the transmission node 20 having received the notification of the decrease in the level has not detected a decrease in the level of the wavelength, the controller 17 of the transmission node 20 determines that failure occurs in the OCM 16 of the relay node 21, and ignores the notification of the decrease in the level. In this case, a normality of the OCM 16 of the relay node 21 is determined through similar processing performed between the relay node 21 and the reception node 22.

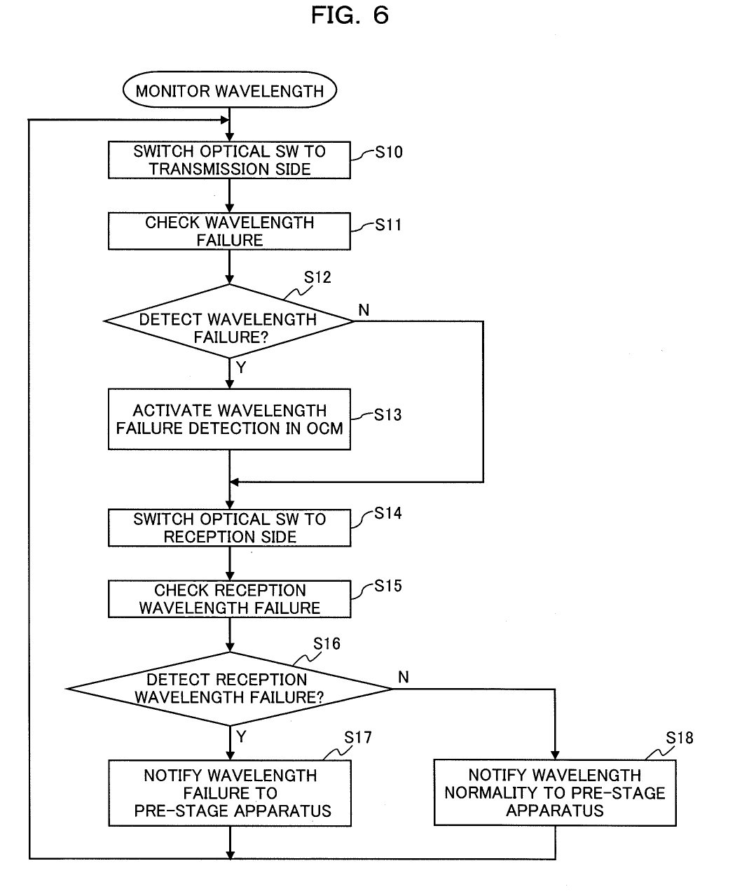

FIG. 6 is a flowchart illustrating wavelength monitor processing in the OCM 16.

When the WSS 13 is switched to a transmission side so that the WDM signal transmitted to the post-stage node is input into the OCM 16 (S10), the OCM 16 determines whether a wavelength channel failure occurs or not (S11). When a wavelength channel failure is detected (Y of S12), the OCM 16 asserts a detection of a wavelength channel failure (S13). Meanwhile, when a wavelength channel failure is not detected (N of S12), processing proceeds on to S14.

When the WSS 13 is switched to a reception side so that the WDM signal received from the pre-stage node is input into the OCM 16 (S14), the OCM 16 determines whether a wavelength channel failure occurs or not (S15). When a wavelength channel failure is detected (Y of S16), a notification indicative of the failure of the wavelength is notified to the pre-stage apparatus (S17), and thereafter, processing is returned to S10. Meanwhile, when a wavelength channel failure is not detected (N of S16), a notification indicative of a normality of the wavelength is notified to the pre-stage apparatus (S18), and thereafter, processing is returned to S10.

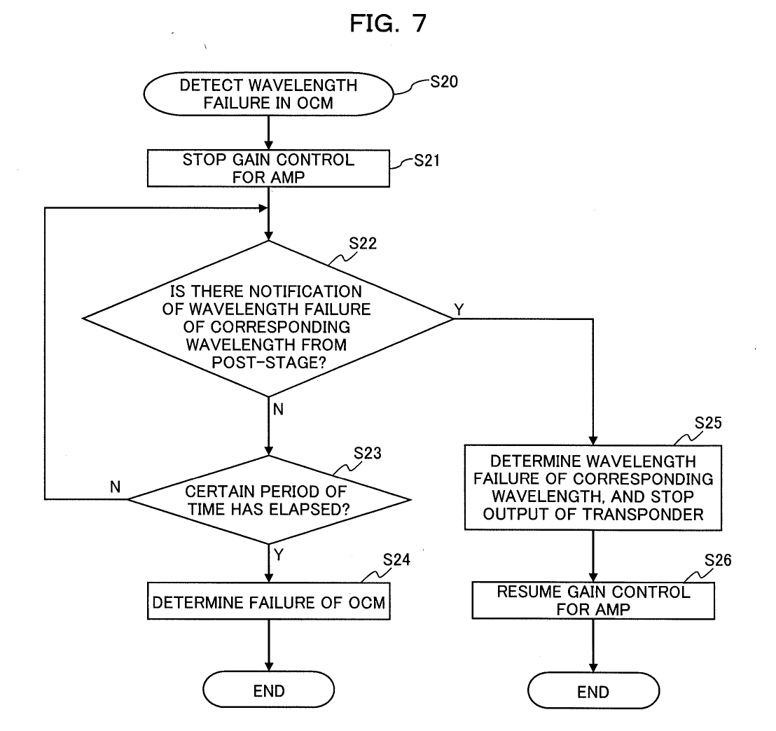

FIG. 7 is a flowchart illustrating determination processing upon detecting a wavelength channel failure. When the OCM 16 detects a failure of a certain wavelength (S20), the controller 17 stops a gain control of the optical amplifier 11 (S21). Thereafter, the controller 17 checks whether or not a notification of the wavelength channel failure for the certain wavelength is received from the post-stage apparatus (S22).

When no wavelength channel failure notification of the wavelength is received from the post-stage apparatus (N of S22), the controller 17 checks whether or not a certain period of time has elapsed (S23). When the certain period of time has not yet elapsed (N of S23), processing is returned to S22. Meanwhile, when the certain period of time has elapsed (Y of S23), the controller 17 determines that a failure occurs in the OCM 16 (S24).

When a wavelength channel failure notification of the certain wavelength is received from the post-stage apparatus (Y of S22), the controller 17 determines that a failure occurs in the certain wavelength, and stops the output of the transponder of the corresponding wavelength (S25), and resumes the gain control of the optical amplifier 11 (S26).

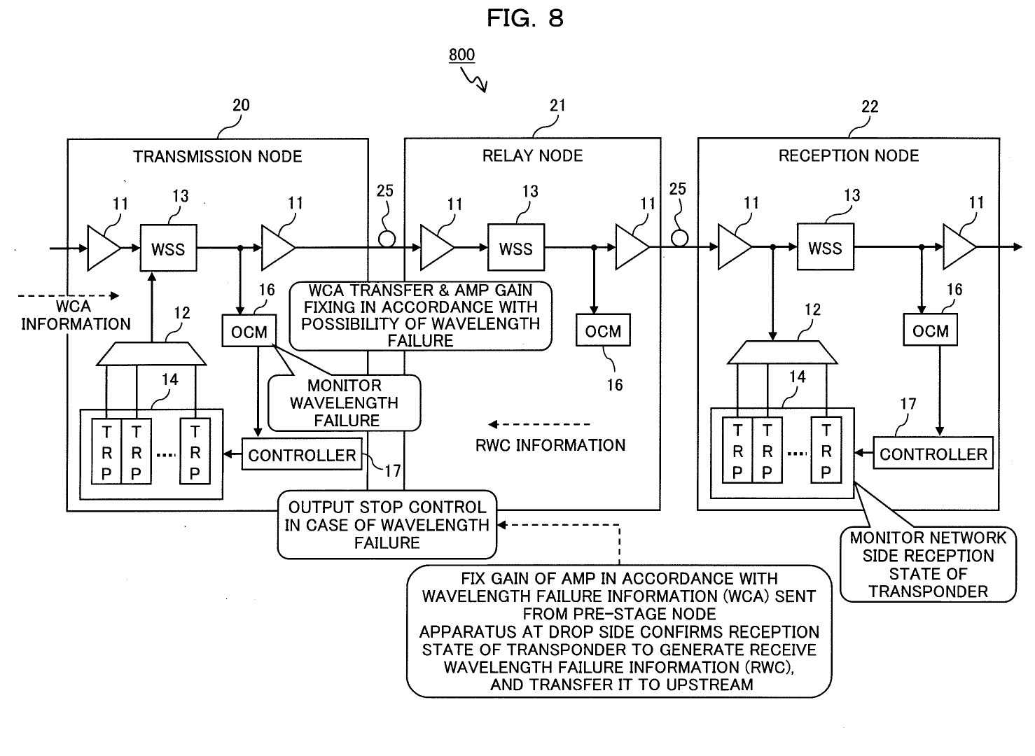

FIG. 8 is a diagram illustrating a WDM transmission system 800 according to another embodiment. As illustrated in FIG. 8, unlike the WDM transmission system 100 explained above, an optical switch is not provided at a pre-stage of the OCM 16.

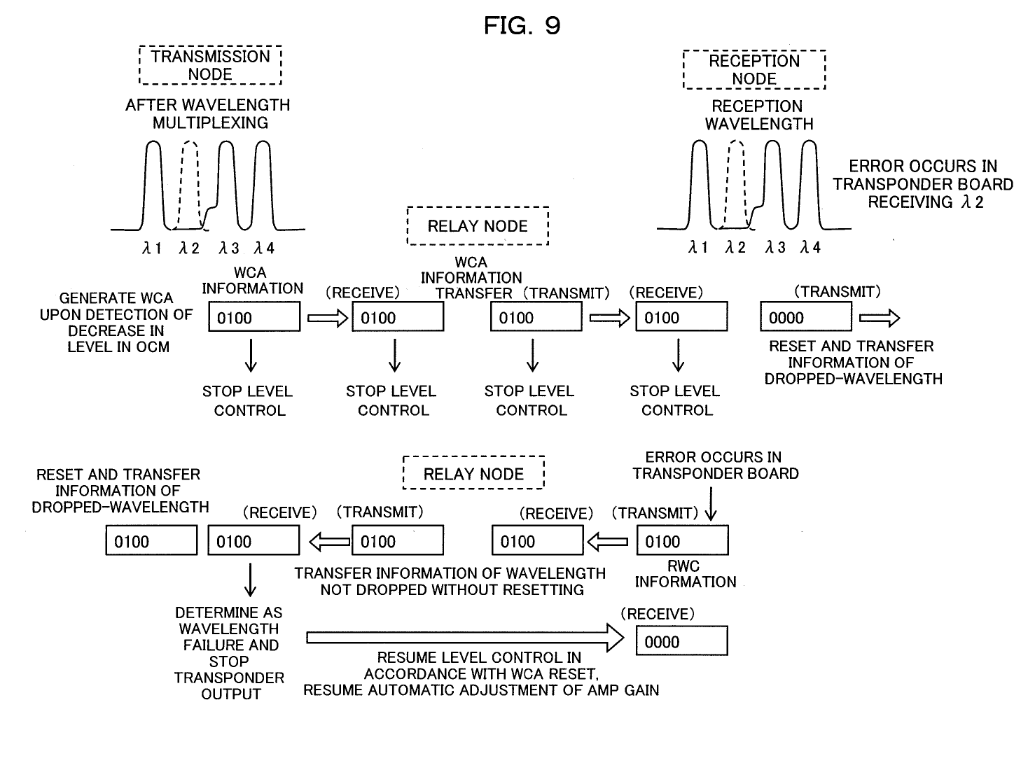

FIG. 9 is a diagram illustrating a wavelength channel failure determination in the WDM transmission system 800 according to another embodiment. An operation of the WDM transmission system 800 will be explained with reference to FIGS. 8 and 9. In this case, it is assumed that an optical signal of the wavelength λ2 added at the transmission node 20 is allowed to pass through at the relay node 21 and the optical signal is then dropped at the reception node 22.

When the OCM 16 of the transmission node 20 detects a decrease in the level of the wavelength (λ2) in a WDM signal, the controller 17 of the transmission node 20 transits from a normal mode to a wavelength channel failure check mode. The controller 17 of the transmission node 20 stops the feedback control of the optical level of each wavelength by the WSS 13, and fixes the gain of the optical amplifier 11 of the transmission side. Then, the controller 17 of the transmission node 20 transfers wavelength channel alarm (WCA) information indicative of a wavelength with which a missing wavelength may occur to a downstream apparatus by using the OSC signal. For example, as illustrated in FIG. 9, the WCA information can be achieved by changing a bit corresponding to λ2 in a WCA information field of an OSC signal from “0” to “1”.

In order to prevent an effect on another wavelength caused by the missing wavelength, the relay node 21 having received the WCA information holds the gain control of the optical amplifier 11 at the reception side and the transmission side, and transmits the WCA information to the reception node 22.

When the controller 17 of the reception node 22 receives the WCA information, the controller 17 of the reception node 22 fixes the gain of the optical amplifier 11 at the reception side. Since the optical signal of the wavelength λ2 is dropped at the reception node 22, the WCA information is reset by changing a bit corresponding to λ2 in the WCA field of the OSC signal from “1” to “0”, and transferred to a post-stage apparatus.

A code error occurs in the optical signal of the wavelength λ2 in the transponder block 14 of the reception node 22 when the controller 17 of the reception node 22 receives the WCA information, the controller 17 of the reception node 22 transfers receive wavelength channel fail (RWC) information to an upstream apparatus. For example, as illustrated in FIG. 9, the RWC information can be achieved by changing a bit corresponding to λ2 in the RWC information field of the OSC signal from “0” to “1”.

The transmission node 20 having transited to the wavelength channel failure check mode monitors the RWC information from a downstream apparatus for a certain period of time. When the code error occurs in the reception node 22, The reception node 20 determines that a failure occurs in the wavelength λ2. Meanwhile, the controller 17 of the transmission node 20 stops the output of the optical signal of the wavelength λ2 from the transponder block 14 upon determining that a failure occurs in the wavelength λ2 in the transponder block 14 of the transmission node 20. The controller 17 of the transmission node 20 releases the wavelength channel failure check mode of the transmission node 20 and the downstream apparatus by resetting the WCA information (i.e., changing all of the bits of the WCA field of the OSC signal to “0”).

Meanwhile, when the RWC information is not transferred from the downstream apparatus after the transmission node 20 transits into the wavelength channel failure check mode, the controller 17 of the transmission node 20 determine that a failure does not occur in the wavelength λ2 and that a failure occurs in the OCM 16 of the transmission node 20. In this case, the controller 17 of the transmission node 20 notifies an alarm to the host monitor apparatus, and holds the wavelength channel failure check mode to prevent a signal interruption due to an erroneous level control on the transmission wavelength. Thereafter, when the OCM 16 of the transmission node 20 is replaced or repaired, the wavelength channel failure check mode of the transmission node 20 and the downstream apparatus is released (i.e., returning back to the normal mode) by resetting the WCA information.

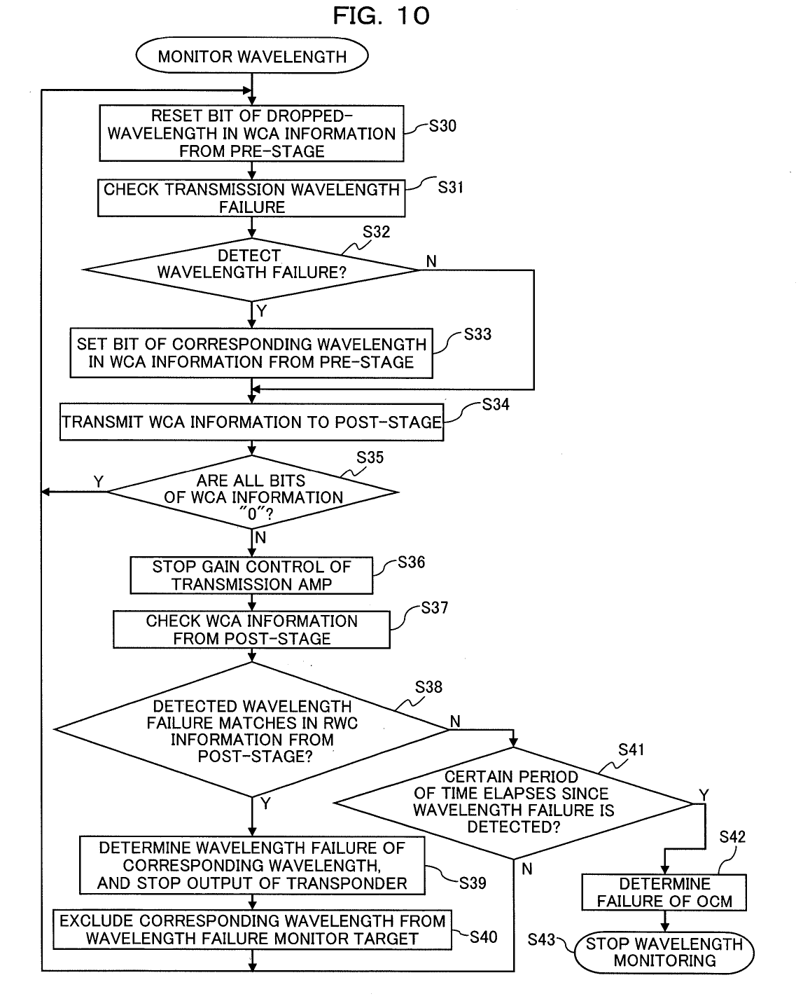

FIG. 10 is a flowchart illustrating wavelength monitor processing in the OCM 16.

Firstly, the controller 17 resets a bit of the drop wavelength in the WCA received from the pre-stage apparatus (S30). Subsequently, the controller 17 checks whether or not a wavelength channel failure occurs in the OCM 16 (S31). When a failure is detected for a certain wavelength (Y of S32), the controller 17 set a bit corresponding to the wavelength in the WCA information received from the pre-stage apparatus to “1” (S33). Thereafter, processing proceeds on to S34. Meanwhile, when a failure is not detected in any wavelengths (N of S32), processing proceeds on to S34. In S34, the controller 17 transmits the WCA information to the post-stage apparatus.

Subsequently, the controller 17 checks whether all of the bits of the WCA information are “0” (S35). When all of the bits of the WCA information are “0” (Y of S35), processing is returned to S30. Meanwhile, when any one of the bits of the WCA information is not “0” (N of S35), the gain control of the optical amplifier 11 at the transmission side is stopped (S36).

Thereafter, the controller 17 checks the RWC information from the post-stage apparatus (S37) to determine whether or not the wavelength for which the wavelength channel failure is detected matches the RWC information from the post-stage (S38).

When the wavelength for which the wavelength channel failure is detected matches the RWC information from the post-stage (Y of S38), the controller 17 determines that the wavelength channel failure occurs in the wavelength, and stops the output of the transponder (S39). Then, the controller 17 excludes the wavelength from a monitor target of the wavelength channel failure (S40).

Meanwhile, when the wavelength for which the wavelength channel failure is detected does not match the RWC information from the post-stage (N of S38), the controller 17 determines whether or not a certain period of time has elapsed from the detection of the wavelength channel failure (S41).

When the certain period of time has not elapsed from the detection of the wavelength channel failure (N of S41), processing is returned to S30. Meanwhile, when the certain period of time has elapsed from the detection of the wavelength channel failure (Y of S41), the controller 17 determines that a failure occurs in the OCM 16 of the own apparatus (S42), and stops the wavelength monitor (S43).

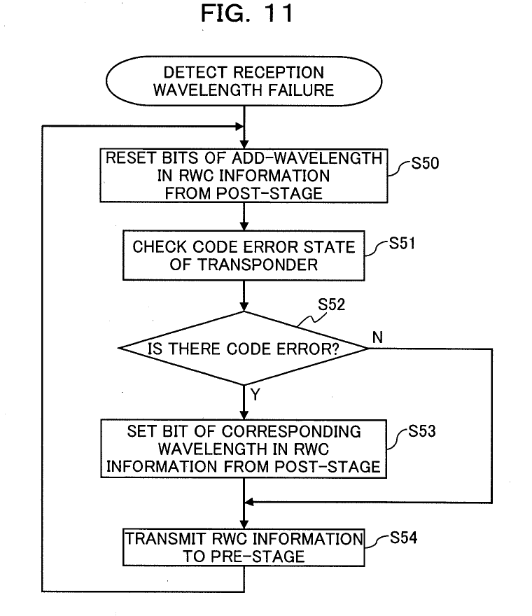

FIG. 11 is a flowchart illustrating determination processing of reception wavelength channel failure. The controller 17 resets a bit corresponding to the added wavelength in the RWC information received from the post-stage (S50). Subsequently, the controller 17 checks a code error state of the transponder (S51). When there is a code error (Y of S52), the bit corresponding to the wavelength is set in the RWC information from the post-stage (S53), and the RWC information is transmitted to the pre-stage apparatus (S54). Meanwhile, when there is no code error (N of S52), the reset RWC information is transmitted (S54).

According to the WDM transmission system 800 explained above, it is not necessary to provide an optical switch 40 in each WDM apparatus 10, and therefore, the WDM transmission system 800 is more advantageous in cost than that of the WDM transmission system 100.

As described above, according to the WDM transmission systems 100 and 800 of the embodiments, even when an occurrence of a wavelength channel failure is detected in the WDM apparatus, it is possible to accurately determine whether a failure in the transponder block 14 or an erroneous detection due to a failure of the OCM 16 to prevent an adverse impact on a connectivity of a subsequent main signal. With no adverse impact on the main signal, it is possible to provide a highly reliable network by maintaining the connectivity of the main signal.

The above-described embodiments are merely examples, and a person skilled in the art would understand that various modifications are available in a combination of constituent elements and processing processes thereof, and such modifications are within the scope of the present invention.

According to the embodiment(s), it is possible to provide a WDM transmission system available to accurately determine a wavelength channel failure in a transponder.

All examples and conditional language provided herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A wavelength division multiplexing transmission system comprising:
a first wavelength division multiplexing transmission apparatus; and
a second wavelength division multiplexing transmission apparatus disposed at a post-stage of the first wavelength division multiplexing transmission apparatus,
wherein each of the first and second wavelength division multiplexing transmission apparatuses includes:
a transponder configured to convert a client signal into optical signals with a plurality of different wavelengths;
a multiplexer configured to wavelength-division-multiplexes the optical signals with the plurality of wavelengths from the transponder;
an optical level detector configured to detect an optical level of each wavelength input into the multiplexer from the transponder;
a wavelength selective switch configured to selectively add or drop the optical signal from a pre-stage apparatus and the wavelength multiplex signal from the multiplexer, or to selectively allow the optical signal from a pre-stage apparatus and the wavelength multiplex signal from the multiplexer to pass through;
an optical channel monitor configured to detect an optical level of each wavelength of the wavelength multiplex signal;
an optical switch provided at a pre-stage of the optical channel monitor, and configured to input any one of the wavelength multiplex signal received from the pre-stage apparatus and a wavelength multiplex signal transmitted to a post-stage apparatus into the optical channel monitor; and
a controller configured to control each constituent element of the wavelength division multiplexing transmission apparatus,
wherein the controller of the second wavelength division multiplexing transmission apparatus at the post-stage notifies level decrease information to the first wavelength division multiplexing transmission apparatus, upon detecting a decrease in a level of a wavelength in the wavelength multiplex signal received from the first wavelength division multiplexing transmission apparatus by the optical channel monitor of the second wavelength division multiplexing transmission apparatus detects, and
wherein the controller of the first wavelength division multiplexing transmission apparatus at the pre-stage determines that a failure occurs in the wavelength of the transponder of the first wavelength division multiplexing transmission apparatus, upon detecting a decrease in the level of the wavelength in the wavelength multiplex signal transmitted to the second wavelength division multiplexing transmission apparatus by the optical channel monitor of the first wavelength division multiplexing transmission apparatus and upon receiving the level decrease information for the wavelength from the second wavelength division multiplexing transmission apparatus.

2. The wavelength division multiplexing transmission system according to claim 1, wherein the controller of the first wavelength division multiplexing transmission apparatus stops an output of the optical signal of the wavelength from the transponder, upon determining that the failure occurs in the wavelength of the transponder of the first wavelength division multiplexing transmission apparatus.

3. The wavelength division multiplexing transmission system according to claim 1, wherein the controller of the first wavelength division multiplexing transmission apparatus determines that a failure occurs in the optical channel monitor of the first wavelength division multiplexing transmission apparatus, when the optical channel monitor of the first wavelength division multiplexing transmission apparatus has not received the level decrease information for the wavelength from the second wavelength division multiplexing transmission apparatus even though the optical channel monitor of the first wavelength division multiplexing transmission apparatus detects a decrease in the level of the wavelength in the wavelength multiplex signal transmitted to the second wavelength division multiplexing transmission apparatus.

4. The wavelength division multiplexing transmission system according to claim 3, wherein the wavelength selective switch performs, based on optical level information for each wavelength of the wavelength multiplex signal from the optical channel monitor, feedback control during normal operation such that the optical level of each wavelength becomes uniform, and
the controller of the first wavelength division multiplexing transmission apparatus stops the feedback control of the optical level of each wavelength in the wavelength selective switch, upon determining that the failure occurs in the optical channel monitor of the first wavelength division multiplexing transmission apparatus.

5. A wavelength division multiplexing transmission system comprising:
a first wavelength division multiplexing transmission apparatus; and
a second wavelength division multiplexing transmission apparatus disposed at a post-stage of the first wavelength division multiplexing transmission apparatus,
wherein each of the wavelength division multiplexing transmission apparatuses includes:
a transponder configured to convert a client signal into optical signals with a plurality of different wavelengths and to detect a code error of the optical signal of each wavelength;
a multiplexer configured to wavelength-division-multiplexes the optical signals with the plurality of wavelengths from the transponder;
an optical level detector configured to detect an optical level of each wavelength input into the multiplexer from the transponder;
a wavelength selective switch configured to selectively add or drop the optical signal from a pre-stage apparatus and the wavelength multiplex signal from the multiplexer, or to selectively allow the optical signal from the pre-stage apparatus and the wavelength multiplex signal from the multiplexer to pass through;
an optical channel monitor configured to detect an optical level of each wavelength in the wavelength multiplex signal;
a transmission optical amplifier configured to amplify a wavelength multiplex signal from the wavelength selective switch and to transmit the wavelength multiplexed signal to a post-stage apparatus;
a reception optical amplifier configured to amplify a wavelength multiplex signal received from the post-stage apparatus to input the wavelength multiplexed signal into the wavelength selective switch; and
a controller configured to control each constituent element of the wavelength division multiplexing transmission apparatus,
wherein the controller of the first wavelength division multiplexing transmission apparatus at the pre-stage fixes a gain of the transmission optical amplifier of the first wavelength division multiplexing transmission apparatus, and notifies wavelength channel alarm information of a wavelength to the second wavelength division multiplexing transmission apparatus, upon detecting a decrease in a level of the wavelength in the wavelength multiplex signal by the optical channel monitor of the first wavelength division multiplexing transmission apparatus,
wherein the controller of the second wavelength division multiplexing transmission apparatus at the post-stage fixes a gain of the reception optical amplifier of the second wavelength division multiplexing transmission apparatus upon receiving the wavelength channel alarm information, and notifies receive wavelength channel fail information to the first wavelength division multiplexing transmission apparatus upon detecting an occurrence of a code error in the optical signal of the wavelength by the transponder of the second wavelength division multiplexing transmission apparatus, and
wherein the first wavelength division multiplexing transmission apparatus determines that a failure occurs in the wavelength of the transponder of the first wavelength division multiplexing transmission apparatus upon receiving the receive wavelength channel fail information.

6. The wavelength division multiplexing transmission system according to claim 5, wherein the controller of the first wavelength division multiplexing transmission apparatus stops an output of the optical signal of the wavelength from the transponder upon determining that a failure occurs in the wavelength of the transponder of the first wavelength division multiplexing transmission apparatus.

7. The wavelength division multiplexing transmission system according to claim 5, wherein the controller of the first wavelength division multiplexing transmission apparatus determines that a failure occurs in the optical channel monitor of the first wavelength division multiplexing transmission apparatus, when the optical channel monitor of the first wavelength division multiplexing transmission apparatus has not received the receive wavelength channel fail information from the second wavelength division multiplexing transmission apparatus even though the optical channel monitor of the first wavelength division multiplexing transmission apparatus detects a decrease in the level of the wavelength in the wavelength multiplex signal transmitted to the second wavelength division multiplexing transmission apparatus.

8. The wavelength division multiplexing transmission system according to claim 7, wherein the wavelength selective switch performs, based on optical level information for each wavelength in the wavelength multiplex signal from the optical channel monitor, feedback control during normal operation such that the optical level of each wavelength becomes uniform, and
wherein the controller of the first wavelength division multiplexing transmission apparatus stops the feedback control of the optical level for each wavelength in the wavelength selective switch, upon determining that a failure occurs in the optical channel monitor of the first wavelength division multiplexing transmission apparatus.
